(19) United States
(12) Patent Application Publication
(10) Pub. No.: US 2011/0123806 A1
(43) Pub. Date: May 26, 2011

(54) DISPERSION OF HYDROPHOBICIZED SILICON DIOXIDE PARTICLES AND GRANULES THEREOF

(75) Inventors: Wolfgang Lortz, Waechtersbach (DE); Gabriele Perlet, Grosskrotzenburg (DE); Uwe Diener, Grosskrotzenburg (DE); Sascha Reitz, Hanau (DE)

(73) Assignee: EVONIK DEGUSSA GMBH, Essen (DE)

(21) Appl. No.: 12/996,635

(22) PCT Filed: Jun. 3, 2009
(86) PCT No.: PCT/EP2009/056802

§ 371 Date: Dec. 7, 2010

(30) Foreign Application Priority Data
Jul. 18, 2008 (EP) 08160711.1

(51) Int. Cl. B32B 1/00; C09D 7/12; B82Y 30/00

(52) U.S. Cl. 428/405; 106/287.1; 977/773

(57) ABSTRACT

Process for preparing a dispersion of surface-modified silicon dioxide particles having an average particle diameter of not more than 100 nm by high-pressure milling of a preliminary dispersion comprising a) 10% to 50% by weight of surface-modified silicon dioxide particles, b) at least one glycol monoether of the general formula (A): H₃C(CH₂)ₘ—O—(CH₂)ₙ—[O—(CH₂)ₒ]ₚ—OH, c) at least one carboxylic ester of the general formula (B): H₂ₓ₊₁Cₓ—O—CH₂—(CHR)—[O—CHR]_{y}—O—C(═O)—C_{z}H_{2z+1}, d) the molar ratio A/B being 10:90 to 40:60 and m, n, o, p, x, y and z being independent of one another. Dispersion obtainable by this process. Process for producing granules of surface-modified silicon dioxide particles by separating off the liquid phase of the dispersion. Granules obtainable by this process. Use of dispersion and granules in coating materials.

The invention relates to a process for preparing a dispersion of surface-modified silicon dioxide particles in an organic solvent, and also to the dispersion itself as obtainable by the process. The invention further relates to a process for producing granules on the basis of the dispersion, and to the granules themselves.

Silicon dioxide particles as a constituent of coating formulations have been known for some considerable time. The main focus of the current research is in the provision of coating formulations which exhibit in particular a high degree of transparency and scratch resistance in tandem with good processing properties and storage stability.

EP-A-943664 discloses a nanoparticle-containing, transparent, film-forming binder which is obtained by nozzle-jet dispersing of nanoscale particles in the binder. Examples of nanoscale particles which can be used include hydrophobicized, pyrogenically prepared silicon dioxide particles.

EP-A-1923412, in contrast, observes that the process disclosed in EP-A-943664 does not allow sufficient dispersion of the hydrophobicized, pyrogenically prepared silicon dioxide particles used and that consequently there are instances of hazing in the film-forming binder.

EP-A-1923412 further observes that pyrogenically prepared silicon dioxide particles have an aggregate structure which makes them poorly suited in principle as a constituent of coating formulations for highly transparent coating materials.

DE-A-102006020987 as well remarks that instances of hazing in coating formulations are likely when using pyrogenically prepared silicon dioxide. DE-A-102006020987 therefore proposes using a special structurally modified pyrogenic (fumed) silicon dioxide. The silicon dioxide particles can be structurally modified by means, for example, of mechanical action and subsequent milling in a mill. By this means it is possible to reduce instances of hazing in coating formulations.

Pyrogenically prepared silicon dioxide particles are distinguished by their ready availability and high purity. In dispersions, their generally aggregated structure often leads to inadequate transparency. Although the use of ball mills can be used to increase the transparency, the material abraded from the balls contaminates the dispersion. It is also seen that, under energetic dispersing conditions, organic dispersing additives may be degraded, and this can lead to instances of hazing, reduced stability and increased viscosity.

It was an object of this invention, therefore, to provide aggregated silicon dioxide particles, especially those prepared pyrogenically, in a form that allows their use in transparent coating formulations.

The invention provides a process for preparing a dispersion of surface-modified silicon dioxide particles having an average particle diameter of not more than 100 nm by high-pressure milling of a preliminary dispersion comprising
a) 10% to 50% by weight of surface-modified silicon dioxide particles which
   are at least partly aggregated and
   are connected via Si—O—Si bonds to the surface-modifying component and
   still have reactive groups on their surface,
b) at least one glycol monoether of the general formula A

H₃C(CH₂)ₘ—O—(CH₂)ₙ—[O—(CH₂)ₒ]ₚ—OH (A)
where
m=0, 1, 2 or 3,
n and o=2, 3 or 4, and
p=0 or 1,
c) at least one carboxylic ester of the general formula B

H₂ₓ₊₁Cₓ—O—CH₂—(CHR)—[O—CHR]_{y}—O—C(═O)—C_{z}H_{2z+1} (B)
where
R=H, CH₃, C₂H₅ or C₃H₇,
x and z=1, 2 or 3, and
y=0 or 1,
d) the molar ratio A/B being 10:90 to 40:60 and m, n, o, p, x, y and z being independent of one another.

The reactive groups on the particle surface are groups which are already present on the particles used and also groups which are formed during the dispersing operation.

The reactive groups are predominantly or exclusively OH groups. These reactive groups may react either completely or only partly with the constituents of the liquid phase, to form covalent, ionic or coordinative bonds. Part of the reason for this is that, for example, individual reactive groups on the surface-modified silicon dioxide particles used are sterically inaccessible owing to the shielding of the surface-modifying compounds.

In the process of the invention at least some of the surface-modified silicon dioxide particles used are in the form of aggregates. By some is meant that the fraction of aggregated particles is at least 5% by weight, based on the sum of the aggregates and unaggregated particles—in accordance with the present invention these are primary particles. It is preferred, however, to use particles which are very largely in aggregated form, in other words to an extent of at least 80% by weight, generally at least 90% by weight, based on the sum of the aggregates and unaggregated particles. The fractions may be determined by means, for example, of counting from TEM (transmission electron microscopy) micrographs.

By aggregates are meant primary particles which are firmly connected via—for example—sinter necks. The aggregates in their turn may congregate to form agglomerates, in which the aggregates are only joined loosely to one another. Agglomerates can be split up again by introducing just low shearing energies.

The average particle diameter of the particles present in the dispersion after the high-pressure milling operation, and comprising aggregates and primary particles, is not more than 100 nm. Preferably it is 50 to 100 nm, and more preferably 60 to 90 nm.

The average particle diameter of the particles present in the preliminary dispersion is greater than 100 nm. The average particle diameter may be 200 nm to several hundred micrometers, and encompasses not only aggregates but also agglomerates. It may be determined, for example, by dynamic light scattering. The preliminary dispersion can be prepared at significantly lower shear rates than the dispersion of the invention. For example, simple stirrers or dissolves can be used. The major purpose of the preliminary dispersion is to disrupt any agglomerates of surface-modified silicon dioxide particles which may come about as a result of the congregation of aggregates by way of cohesive forces.

Depending on the particular surface modifier used and on its particular amount, it is possible to prepare silicon dioxide particles having different degrees of hydrophobic or hydrophilic behaviour. One measure of the degree of the surface properties of the surface-modified silicon dioxide particles used in the process, hydrophilic to hydrophobic, is the methanol wettability. For the determination of the methanol wettability, 0.2 g (±0.005 g) of surface-modified silicon dioxide particles are weighed out into transparent centrifuge tubes. To each sample are added 8.0 ml of a methanol/water mixture containing respectively 10%, 20%, 30%, 40%, 50%, 60%, 70% and 80% by volume of methanol. After sealing, the tubes are shaken for 30 seconds and then centrifuged for 5 minutes at 2500 min⁻¹. The volumes of sediment are read off, converted to a percentage, and plotted against the methanol content (% by volume). The point of inflexion of the graph corresponds to the methanol wettability. The higher the methanol wettability, the greater the hydrophobicity of the silicon dioxide particles. The methanol wettability of the surface-modified silicon dioxide particles used is preferably 20 to 50, more preferably 25 to 45 and very preferably 30 to 40.

In general, not all of the reactive groups of the surface-modified silicon dioxide particles used react with the surface modifier. For example, a part is played by the accessibility of the reactive groups.

In one preferred embodiment of the process of the invention it is possible to use surface-modified silicon dioxide particles which have been obtained by surface modification of silicon dioxide particles obtained pyrogenically—that is, by flame hydrolysis or flame oxidation. Products which have been structurally modified subsequently can be used as well. The structural modification of the surface-modified silicon dioxide particles can be accomplished by mechanical action and by subsequent milling where appropriate. The structural modification may take place, for example, with a ball mill, including a continuously operating ball mill. The subsequent milling may take place, for example, by means of an air jet mill, toothed disc mill or pinned disc mill. The structural modification is also described in EP-A-808880 and DE-A-102006048509.

Modifiers for preparing the surface-modified silicon dioxide particles present in the preliminary dispersion are those which contain at least one functional group which forms an Si—O—Si bond with the reactive groups on the particle surface of the silicon dioxide particles to be modified.

In addition to the functional group which is able to enter into a chemical bond with the surface group of the particle, the modifier generally contains a moiety which, after linkage of the surface modifier, is able to give the particle a greater or lesser degree of hydrophobic or hydrophilic properties.

Surface modifiers used with preference in preparing the surface-modified silicon dioxide particles used are silanes. The carbon chains of these compounds may be interrupted by O, S or NH groups. It is possible to use one or more modifiers. The silanes used contain at least one non-hydrolysable group.

Preferred silanes have the general formula RₓSiY₄₋ₓ (I), in which x has a value of 1, 2 or 3 and the radicals R are alike or different and are non-hydrolysable radicals, while the radicals Y are alike or different and are hydrolysable groups or hydroxyl groups.

In the general formula (I) the hydrolysable groups Y, which may be alike or different from one another, are for example
hydrogen,
halogen, for example F, Cl, Br or I,
alkoxy, preferably C₁-C₆ alkoxy, such as methoxy, ethoxy, n-propoxy, isopropoxy and butoxy,
aryloxy, preferably C₆-C₁₀ aryloxy, such as phenoxy,
acyloxy, preferably C₁-C₆ acyloxy, such as acetoxy or propionyloxy,
alkylcarbonyl, preferably C₂-C₇ alkylcarbonyl, such as acetyl.

Preferred hydrolysable radicals are halogen, alkoxy groups and acyloxy groups. Particularly preferred hydrolysable radicals are C₁-C₄ alkoxy groups, especially methoxy and ethoxy.

The non-hydrolysable radicals R, which may be alike or different from one another, are radicals R with or without a functional group.

The non-hydrolysable radical R without a functional group is for example
alkyl, preferably C₁-C₈ alkyl, such as methyl, ethyl, n-propyl, isopropyl, n-butyl, sec-butyl and tert-butyl, pentyl, hexyl, octyl or cyclohexyl; substituted alkyl,
alkenyl, preferably C₂-C₆ alkenyl, such as vinyl, 1-propenyl, 2-propenyl and butenyl,
alkynyl, preferably C₂-C₆ alkynyl, such as acetylenyl and propargyl,
aryl, preferably C₆-C₁₀ aryl, such as phenyl and naphthyl, and also corresponding alkaryls and aralkyls such as tolyl, benzyl and phenethyl.

Preferred surface modifiers may be, in particular, CH₃SiCl₃, CH₃S (OC₂H₅)₃, CH₃S (OCH₃)₃, C₂H₅SiCl₃, C₂H₅S (OC₂H₅)₃, C₂H₅S (OCH₃)₃, C₃H₇Si(OC₂H₅)₃, (C₂H₅O)₃SiC₃H₆Cl, (CH₃)₂SiCl₂, (CH₃)₂Si(OC₂H₅)₂, (CH₃)₂Si(OH)₂, C₆H₅S (OCH₃)₃, C₆H(Si (OC₂H₅)₃, C₆H₅CH₂CH₂Si(OCH₃)₃, (C₆H₅)₂SiCl₂, (C₆H₅)₂Si(OC₂H₅)₂, (iso-C₃H₇)₃SiOH, CH₂═CHSi(OC₂H₅)₃, CH₂═CH—Si(OC₂H₄OCH₃)₃, CH₂═CH—CH₂—Si(OC₂H₅)₃, CH₂═CH—Si(OC₂H₄OCH₃)₃, CH₂═CH—CH₂—Si(OC₂H₅)₃, CH₂═CH—CH₂—Si(OC₂H₅)₃, CH₂═CH—CH₂—Si (OOCH₃)₃, n-C₆H₁₃—CH₂—CH₂—Si(OC₂H₅)₃, and n-C₈H₁₇—CH₂—CH₂—Si(OC₂H₅)₃.

A non-hydrolysable radical R with a functional group may comprise as its functional group, for example, an epoxide (such as glycidyl or glycidyloxy), hydroxyl, ether, amino, monoalkylamino, dialkylamino, optionally substituted anilino, amide, carboxyl, acryloyl, acryloyloxy, methacryloyl, methacryloyloxy, mercapto, cyano, alkoxy, isocyanato, aldehyde, alkylcarbonyl, acid anhydride and phosphoric acid group.

Preferred examples of non-hydrolysable radicals R with functional groups are
a glycidyl or a glycidyloxy-(C₁-C₂₀)-alkylene radical, such as beta-glycidyloxyethyl, gamma-glycidyloxypropyl, delta-glycidyloxybutyl, epsilon-glycidyloxypentyl, omega-glycidyloxyhexyl and 2-(3,4-epoxycyclohexyl)ethyl,
(meth)acryloyloxy-(C₁-C₆)-alkylene radical, such as (meth) acryloyloxymethyl, (meth) acryloyloxyethyl, (meth)acryloyloxypropyl or (meth)acryloyloxybutyl, and
3-isocyanatopropyl radical.

Specifically it is possible as surface modifiers to use
gamma-glycidyloxypropyltrimethoxysilane,
glycidyloxypropyltriethoxysilane,
3-isocyanatopropyltriethoxysilane,
3-isocyanatopropyldimethylchlorosilane,
aminopropyltriethoxysilane, aminopropyltrimethoxysilane,
aminomethyltriethoxysilane, aminomethyltrimethoxysilane,
aminopropyltrichlorosilane,
(N-cyclohexylaminomethyl)triethoxysilane,
2-aminoethyl-3-aminopropyltrimethoxysilane,
N-(n-butyl)-3-aminopropyltrimethoxysilane,
2-aminoethyl-3-aminopropylmethyldimethoxysilane,
(3-aminopropyl) diethoxymethylsilane,
(3-aminopropyl)ethyldiethoxysilane,
(3-methylaminopropyl)trimethoxysilane,
(aminoethylaminomethyl)phenethyltrimethoxysilane,
(N,N-diethyl-3-aminopropyl) trimethoxysilane,
(N,N-dimethylamino)dimethylchlorosilane,
(N,N-dimethylaminopropyl)trimethoxysilane,
(N-acetylglycyl)-3-aminopropyltrimethoxysilane,
(N-cyclohexylaminomethyl)methyldiethoxysilane,
(N-cyclohexylaminomethyl)triethoxysilane,
(N-phenylaminomethyl)methyldimethoxysilane,
(N-phenylaminomethyl)trimethoxysilane,
11-aminoundecyltrimethoxysilane,
3-(1,3-dimethylbutylidene)aminopropyltriethoxysilane,
3-(1-aminopropoxy)-3,3-dimethyl-1-propenyltrimethoxysilane,
3-(2,4-dinitrophenylamino)propyltriethoxysilane,
3-(2-aminoethylamino)propylmethyldimethoxysilane,
3-(2-aminoethylamino)propyltrimethoxysilane,
3-(cyclohexylamino)propyltrimethoxysilane,
3-(aminophenoxy)propyltrimethoxysilane,
3-(N-allylamino)propyltrimethoxysilane,
3-(N-styrylmethyl-2-aminoethylamino)propyltrimethoxysilane,
3-(phenylamino)propyltrimethoxysilane,
3-aminopropyldiisopropylethoxysilane,
3-aminopropyldimethylethoxysilane,
3-aminopropylmethylbis(trimethylsiloxy)silane,
3-aminopropylmethyldiethoxysilane,
3-aminopropyltris(methoxyethoxyethoxy)silane,
3-aminopropyltris(trimethylsiloxy)silane,
4-aminobutyltriethoxysilane, aminophenyltrimethoxysilane,
bis(2-hydroxyethyl)-3-aminopropyltriethoxysilane,
diethylaminomethyltriethoxysilane,
N,N-dimethylaminomethylethoxysilane,
N-(2-aminoethyl)-3-aminoisobutyldimethylmethoxysilane,
N-(2-aminoethyl)-3-aminopropylmethyldimethoxysilane,
N-(2-aminoethyl)-3-aminopropyltriethoxysilane,
N-(2-aminoethyl)-3-aminopropyltrimethoxysilane,
N-(2-aminomethyl)-11-aminoundecyltrimethoxysilane,
N-(3-acryloyloxy-2-hydroxypropyl)-3-aminopropyltriethoxysilane,
N-(3-methacryloyloxy-2-hydroxypropyl)-3-aminopropyltriethoxysilane,
N-(6-aminohexyl)aminopropyltrimethoxysilane,
N-(hydroxyethyl)-N-methylaminopropyltrimethoxysilane,
N-3-[(amino(polypropylenoxy)]aminopropyltrimethoxysilane,
n-butylaminopropyltrimethoxysilane,
N-cyclohexylaminopropyltrimethoxysilane,
N-ethylaminoisobutylmethyldiethoxysilane,
N-ethylaminoisobutyltrimethoxysilane,
N-methylaminopropylmethyldimethoxysilane,
N-methylaminopropyltrimethoxysilane,
N-phenylaminomethyltriethoxysilane,
phenylbis(dimethylamino)chlorosilane,
tert-butylaminopropyltrimethoxysilane,
aminopropylsilanetriol,
N-(2-aminoethyl)-3-aminopropylsilanetriol,
N-cyclohexylaminomethyltriethoxysilane,
N-cyclohexylaminomethylmethyldiethoxysilane and
N-phenylaminomethyltrimethoxysilane,
3-(meth)acryloyloxypropyltriethoxysilane and
3-(meth)acryloyloxypropyltrimethoxysilane.

Furthermore, the silicon dioxide particles present in the preliminary dispersion may also be surface-modified by silylamines. By silylamines are meant compounds which contain at least one Si—N bond and which are able to react with the Si—OH groups present on the surface of the silicon dioxide particles. Examples of such compounds are vinyldimethylsilylamine, octyldimethylsilylamine, phenyldimethylsilylamine, bis(dimethylaminodimethylsilyl)-ethane, hexamethyldisilazane, (N,N-dimethylamino)-trimethylsilane and bis(trifluoropropyl)tetramethyl-disilazane. Cyclic silazanes can additionally be used.

Also suitable as surface modifiers are the cyclic polysiloxanes D3, D4, D5 and their homologues: D3, D4 and D5 are cyclic polysiloxanes having 3, 4 or 5 units of the type —O—Si(CH₃)₂, for example octamethylcyclotetrasiloxane=D4. Additionally, polysiloxanes or silicone oils of the type Y—O—[(RR′SiO)ₘ—(R″R′″SiO)ₙ]ᵤ—Y, where

m=0, 1, 2, 3, . . . ∞, preferably 0, 1, 2, 3, . . . 100 000,

n=0, 1, 2, 3, . . . ∞, preferably 0, 1, 2, 3, . . . 100 000,

u=0, 1, 2, 3, . . . ∞, preferably 0, 1, 2, 3, . . . 100 000,

Y=CH₃, H, CₙH₂ₙ₊₁, n=2-20; Si(CH₃)₃, Si(CH₃)₂H, Si(CH₃)₂OH, Si(CH₃)₂(OCH₃), Si(CH₃)₂(CₙH₂ₙ₊₁), n=2-20,

R, R′, R″, R′″, in each case independently of one another, are alkyl such as CₙH₂ₙ₊₁, n=1-20; aryl such as phenyl radicals and substituted phenyl radicals, (CH₂)ₙ—NH₂, H. Polysiloxanes or silicone oils are commonly activated thermally for surface modification.

Suitable surface-modified silicon dioxide particles which can be used in the preliminary dispersion are the commercially available materials AEROSIL® R104, AEROSIL® R106, AEROSIL® R202, AEROSIL® R805, AEROSIL® R812, AEROSIL® R812 S, AEROSIL® R972, AEROSIL® R974, AEROSIL® R8200, AEROXIDE® LE-1 and AEROXIDE® LE-2, AEROSIL® R 9200, AEROSIL® R 8200 and AEROSIL® R 7200, all from Evonik Degussa.

The carbon content of the surface-modified silicon dioxide particles used can be preferably 0.1% to 2.5% by weight.

With particular preference it is possible to use AEROSIL® R974, which is obtained by reacting AEROSIL® 200 with dimethyldichlorosilane.

The fraction of the surface-modified silicon dioxide particles used, relative to the preliminary dispersion, is 10% to 50% by weight, and is dependent on factors including the nature of the surface modification of the silicon dioxide particles used, and the composition of the liquid phase. A range from 20% to 40% by weight is preferred.

An essential constituent of the process of the invention are one or more glycol monoethers of the general formula H₃C(CH₂)ₘ—O—(CH₂)ₙ—[O—(CH₂)ₒ]ₚ—OH (A)

where
m=0, 1, 2 or 3,
n and o=2, 3 or 4, and
p=0 or 1.

Preferred possibilities are as follows: m=2 or 3, n=2 or 3, o=2 or 3 and p=0 or 1. Particularly preferred possibilities are as follows: m=2, n=2, o=2 and p=1. With very particular preference it is possible to use H₃C(CH₂)₃—O—(CH₂)₂—OH.

A further essential constituent of the process of the invention are one or more carboxylic esters of the general formula

H₂ₓ₊₁Cₓ—O—CH₂—(CHR)—[O—CHR]_{y}—O—C(═O)—C_{z}H_{2z+1} (B)

where

### R=H, CH₃, C₂H₅, C₃H₇,

x and z=1, 2 or 3, and
y=0 or 1.

Preferred possibilities are as follows: x=1, R=H or CH₃, y=0 or 1 and z=1 or 2.

A particularly preferred possibility is as follows: x=1, R=CH₃, y=0 and z=1, i.e. H₃C—O—CH₂—(CHCH₃)—O—C(═O)—CH₃.

It is essential for the process of the invention, moreover, that the molar ratio H₃C(CH₂)ₘ—O—(CH₂)ₙ[O—(CH₂)ₒ]ₚ—OH (A)/H₂ₓ₊₁Cₓ—O—CH₂—(CHR)—[O—CHR]_{y}—O—C(═O)—C_{z}H_{2z+1} (B) is 10:90 to 40:60, preferably 15:85 to 35:65, more preferably 20:80 to 30:70.

The compounds of the general formulae A and B generally represent the liquid phase of the dispersion of the invention. Said dispersion, however, may also comprise further solvents, which may be added after the high-pressure milling operation. Stirrers or dissolvers, for example, are sufficient for mixing the constituents. Suitable solvents may be alcohols, ethers, ketones and aromatics.

Suitable alcohols may be the following: methanol, ethanol, n-propanol, isopropanol, n-butanol, isobutanol, sec-butanol, tert-butanol, n-pentanol, isopentanol, 2-methylbutanol, sec-pentanol, tert-pentanol, 3-methoxybutanol, n-hexanol, 2-methylpentanol, sec-hexanol, 2-ethylbutanol, sec-heptanol, 3-heptanol, n-octanol, 2-ethylhexanol, sec-octanol, n-nonyl alcohol, 2,6-dimethylheptan-4-ol, n-decanol, sec-undecyl alcohol, trimethylnonyl alcohol, sec-tetradecyl alcohol, sec-heptadecyl alcohol, phenol, cyclohexanol, methylcyclohexanol, 3,3,5-trimethylcyclohexanol, benzyl alcohol, diacetone alcohol, ethylene glycol, 1,2-propylene glycol, 1,3-butylene glycol, 2,4-pentanediol, 2-methyl-2,4-pentanediol, 2,5-hexanediol, 2,4-heptanediol, 2-ethyl-1,3-hexanediol, diethylene glycol, dipropylene glycol, hexanediol, octanediol, triethylene glycol, tripropylene glycol and glycerol.

Suitable esters may include the following: diethyl carbonate, ethylene carbonate, propylene carbonate, methyl acetate, ethyl acetate, gamma-butyrolactone, gamma-valerolactone, n-propyl acetate, isopropyl acetate, n-butyl acetate, isobutyl acetate, sec-butyl acetate, n-pentyl acetate, sec-pentyl acetate, 3-methoxybutyl acetate, methylpentyl acetate, 2-ethylbutyl acetate, 2-ethylhexyl acetate, benzyl acetate, cyclohexyl acetate, methylcyclohexyl acetate, n-nonyl acetate, methyl acetoacetate, ethyl acetoacetate, glycol diacetate, methoxytriglycol acetate, ethyl propionate, n-butyl propionate, isoamyl propionate, diethyl oxalate, di-n-butyl oxalate, methyl lactate, ethyl lactate, n-butyl lactate, n-amyl lactate, diethyl malonate, dimethyl phthalate and diethyl phthalate.

Suitable ethers may include the following: dipropyl ether, diisopropyl ether, dioxane, tetrahydrofuran, tetrahydropyran, ethylene glycol dimethyl ether, ethylene glycol diethyl ether, ethylene glycol dipropyl ether, propylene glycol dimethyl ether, propylene glycol diethyl ether, propylene glycol dipropyl ether, diethylene glycol dimethyl ether, diethylene glycol diethyl ether and diethylene glycol dipropyl ether.

Suitable ketones may include the following: acetone, methyl ethyl ketone, methyl n-propyl ketone, methyl n-butyl ketone, diethyl ketone, methyl isobutyl ketone, methyl n-pentyl ketone, ethyl n-butyl ketone, methyl n-hexyl ketone, di-n-butyl ketone, trimethylnonanone, cyclohexanone, 2-hexanone, methylcyclohexanone, 2,4-pentanedione, acetonylacetone, acetophenone, acetylacetone, 2,4-hexanedione, 2,4-heptanedione, 3,5-heptanedione, 2,4-octanedione, 3,5-octanedione, 2,4-nonanedione, 3,5-nonanedione, 5-methyl-2,4-hexanedione and 2,2,6,6-tetramethyl-3,5-heptanedione.

It is essential, moreover, that the surface-modified silicon dioxide powder used in the preliminary dispersion is passed to a high-pressure milling operation. The high-pressure milling may be performed, for example, by subjecting the preliminary dispersion to a pressure of 50 to 500 MPa and releasing it via a nozzle, such as a perforated or slotted nozzle, for example, the bore diameter or the slot width of the nozzle being 0.05 to 1 mm, preferably 0.1 to 0.5 mm, and the length/diameter ratio of the bore or the depth/slot width ratio of the slot of the nozzle being 1 to 10. After this kind of dispersing the removal of coarse particles, by filtration or sedimentation, for example, may possibly be necessary.

Preference is given to an embodiment of the process of the invention in which the preliminary dispersion is divided into at least two substreams, which are pressurized and released via a respective nozzle towards a common collision point.

The jets of the substreams in this case preferably have a speed of at least 300 m·s⁻¹, more preferably one of 400 to 1000 m·s⁻¹ and very preferably one of 600 to 900 m·s⁻¹. The speed referred to here is the speed of the substreams in the nozzle channel. It is defined as the ratio of the volume flow rate per nozzle in m³·s⁻¹ to the area of the bore of a nozzle in m². The diameter of the bore is generally 0.1 to 1 mm, preferably 0.2 to 0.4 mm.

If the dispersion is intended for the production of a translucent coating rather than a transparent coating, it is possible to replace the high-pressure milling operation by rotor-stator dispersing. The rotor-stator dispersing ought to be carried out preferably at a shear rate of 10⁴ s⁻¹ or more, more preferably at 2·10⁴ to 4·10⁴ s⁻¹.

The invention further provides a dispersion obtainable by the process of the invention.

Further provided by the invention is a process in which granules of surface-modified silicon dioxide particles are obtained by separating off the liquid phase of the dispersion of the invention.

This can be done, for example, by distilling, filtering or centrifuging. The separation of the liquid phase need not be complete. Hence the surface-modified silicon dioxide particles obtained by the process of the invention may still contain adhering solvent. If desired, it is also possible to carry out a drying step afterwards. Similarly, the particles obtained after the separation of the liquid phase may be washed with suitable solvents and afterwards separated off, for example, by filtering or centrifuging.

Spray drying and freeze drying have proved to be suitable methods of separating off the liquid phase.

In the preliminary dispersion it is possible with preference to use surface-modified silicon dioxide particles having a BET surface area of 40 to 200 m²/g and a methanol wettability of 30 to 40 which are obtained by reacting pyrogenically prepared silicon dioxide particles with dimethyldichlorosilane.

The invention further provides granules obtainable by the process of the invention. These granules, despite having a higher tapped density, are significantly easier to disperse than the surface-modified silicon dioxide particles used in preparing the dispersion of the invention.

The invention further provides for the use of the dispersion of the invention or of the granules of the invention in scratch-resistant translucent or transparent coatings.

### EXAMPLES

Determination of the viscosity of the dispersions: the viscosity of the dispersions produced was determined using a Physica model 300 rotational rheometer and the CC 27 measuring cup at 25° C.

Determination of the particle size present in the dispersion: the particle size present in the dispersion is determined by means of dynamic light scattering. The instrument used is the Zetasizer 3000 HSa (Malvern Instruments, UK). The parameter reported is the median of the volume distribution d_{50(V)}.

Determination of the shear rate: the shear rate in accordance with the process of the invention is expressed as the peripheral speed divided by the distance between the surfaces.

The peripheral speeds can be calculated from the rotary speed of the rotor and the diameter of the rotor. The distance between rotor and stator in the dispersing devices employed is approximately 1 mm.

### Example 1 (inventive)

A dissolver is used to prepare a preliminary dispersion containing 30% by weight of AEROSIL® R974, Evonik Degussa, prepared in a mixture of H₃C—O—CH₂—(CHCH₃)—O—C(═O)—CH₃ and H₃C(CH₂)₃—O—(CH₂)₂—OH, molar ratio H₃C(CH₂)₃—O—(CH₂)₂—OH/H₃C—O—CH₂—(CHCH₃)—O—C(═O)—CH₃=22:78.

This preliminary dispersion is then divided into three substreams, which are pressurized and released via a diamond nozzle towards a common collision point, the substreams each having an angle of 120° and a speed of 700 m·s⁻¹. The resulting dispersion is subsequently milled again under the same conditions.

The dispersion obtained has an average particle diameter (median) as determined by dynamic light scattering of 78 nm.

The dispersion obtained by means of rotor-stator dispersing is translucent; the dispersion obtained by means of high-pressure milling is transparent.

The dispersion obtained by means of high-pressure milling has a very low viscosity.

TABLE 1
Viscosity as a function of shear rate

Viscosity [mPa · s]
Example

| Shear rate [s⁻¹] | 1 | 4 | 5a | 5b |
|---|---|---|---|---|
| 0.1 | 22.55 | 92.37 | 89.04 | 11.84 |
| 1.269 | 19.24 | 92.64 | 79.85 | 25.65 |
| 11.72 | 18.8 | 83.72 | 61.01 | 24.42 |
| 108.3 | 17.54 | 64.43 | 42.28 | 18.69 |
| 1000 | 16.1 | 50.71 | 89.04 | 11.84 |

A further feature of the dispersions of the invention is that customary dispersing additives, such as LAD-1045 or Dispers 652, for example, both of which are dispersing additives from Tego, can be incorporated without problems of flocculation or gelling.

The dispersion obtained by high-pressure milling is subsequently spray dried (inert gas: nitrogen, atomization: 2-fluid nozzle, entry temperature: 320° C., exit temperature: 150-170° C.; solids deposition: cyclone/filter).

This gives granules having an average diameter of 30 μm.

### Example 2 (Comparative)

Using a dissolver, 80 g of AEROSIL® R 974 are predispersed in 154.3 g of H₃C—O—CH₂CH(CH₃)—O—C(═O)CH₃ and 25.7 g of H₃C—O—CH₂CH(CH₃)OH, molar ratio H₃C—O—(CH₂)₃—OH/H₃C—O—CH₂CH(CH₃)—O—C(═O)CH₃=20:80, and the preliminary dispersion is subsequently dispersed by means of a rotor-stator machine. The dispersion gels within hours. The preparation of a stable dispersion is not possible.

### Example 3 (inventive)

Using a dissolver, 90 g of AEROSIL® R 974 are predispersed in 180 g of H₃C—O—CH₂CH(CH₃)—O—C(═O)CH₃ and 30 g of H₃C(CH₂)₃—O—(CH₂)₂—OH, molar ratio H₃C(CH₂)₃—O—(CH₂)₂—OH/H₃C—O—CH₂CH(CH₃)—O—C(═O)CH₃=16:84, and the preliminary dispersion is subsequently dispersed by means of a rotor-stator machine. The dispersion exhibits only a slight increase in viscosity over a period of two weeks.

### Example 4 (inventive)

Using a Conti TDS rotor-stator machine, 42.02 kg of H₃C—O—CH₂CH(CH₃)—O—C(═O)CH₃ and 11.46 kg of H₃C(CH₂)₃—O—(CH₂)₂—OH, molar ratio H₃C(CH₂)₃—O—(CH₂)₂—OH/H₃C—O—CH₂CH(CH₃)—O—C(═O)CH₃=23:77, and 22.92 kg of AEROSIL® R 711 are dispersed at a shear rate of 20 000 s⁻¹.

### Example 5a (inventive)

Using a Conti TDS rotor-stator machine, 42.35 kg of H₃C—O—CH₂CH(CH₃)—O—C(═O)CH₃, 11.55 kg of H₃C(CH₂)₃—O—(CH₂)₂—OH, molar ratio H₃C(CH₂)₃—O—(CH₂)₂—OH/H₃C—O—CH₂CH(CH₃)—O—C(═O)CH₃=23:77, and 30.80 kg of AEROSIL® R 972 are dispersed at a shear rate of 20 000 s⁻¹.

### Example 5b

This dispersion is then divided into three substreams, which are pressurized and released via a diamond nozzle towards a common collision point, the substreams each having an angle of 120° and a speed of 700 m·s⁻¹. The resulting dispersion is subsequently milled again under the same conditions.

The dispersion obtained has an average particle diameter (median) as determined by dynamic light scattering of 82 nm.

### Example 6: Preparation of a Coating Material

A coating material having the composition shown in Table 2 is prepared. It is applied by spraying to a black-painted metal sheet DT, and is dried at room temperature for 24 hours and then at 70° C. for 2 hours. The coating material exhibits a low haze with good scratch resistance.

TABLE 2
Coating material (amounts in parts by weight [g])

| | |
|---|---|
| Dispersion from Example 1 | 33 |
| Macrynal SM 565, 70% | 122 |
| Methoxypropyl acetate | 0.5 |
| Butyl acetate | 3 |
| Solvesso 100 | 4 |
| Xylene | 5.4 |

1. A process for preparing a dispersion of surface-modified silicon dioxide particles having an average particle diameter of not more than 100 nm, the process comprising
high-pressure milling a preliminary dispersion,
the preliminary dispersion comprising:
a) 10% to 50% by weight of surface-modified silicon dioxide particles which
are at least partly aggregated, and
are connected via Si—O—Si bonds to a surface-modifying component and still have reactive groups on their surface;
b) at least one glycol monoether of formula (A)
H₃C(CH₂)ₘ—O—(CH₂)ₙ—[O—(CH₂)ₒ]ₚ—OH (A),
where wherein
m=0, 1, or 3,
n and o=2, 3, or 4, and
p=0 or 1;
c) at least one carboxylic ester of formula (B)
H₂ₓ₊₁Cₓ—O—CH₂—(CHR)—[O—CHr]_{y}—O—C(=0)-C_{z}H_{2z+1} (B),
wherein
R=H, CH₃, C₂H₅, or C₃H₇,
x and z=1, or 3, and
y=0 or 1; and wherein
d) a molar ratio A/B is 10:90 to 40:60 and m, n, o, p, x, y and z are independent of one another,
to give the surface-modified silicon dioxide particles having an average particle diameter of not more than 100 nm.

2. The process according to claim 1, wherein the surface-modified silicon dioxide particles are of pyrogenic origin.

3. The process according to claim 1, wherein H₃C(CH₂)₃—O—(CH₂)₂—OH is present.

4. The process according to claim 1, wherein H₃C—O—CH₂—CHCH₃—O—C(═O)—CH₃ is present.

5. The process according to claim 1, wherein the high-pressure milling is carried out by:
dividing the preliminary dispersion into at least two substreams;
pressurizing the at least two substreams; and
releasing the at least two substreams via a respective nozzle towards a common collision point.

6. A dispersion, obtained by the process according to claim 1.

7. A process for producing granules of surface-modified silicon dioxide particles, the process comprising separating off a liquid phase of the dispersion according to claim 6.

8. The process according to claim 7, wherein surface-modified silicon dioxide particles having a BET surface area of 40 to 200 m2/g and a methanol wettability of 30 to 40 are employed, which are obtained by reacting pyrogenically prepared silicon dioxide particles with dimethyldichlorosilane.

9. Granules of surface-modified silicon dioxide particles, obtainable obtained by the process according to claim 7.

10. A scratch-resistant transparent coating, comprising the dispersion according to claim 6 or granules of surface-modified silicon dioxide particles, obtained by separating off a liquid phase of a dispersion, obtained by high-pressure milling a preliminary dispersion comprising:
a) 10% to 50% by weight of surface-modified silicon dioxide particles which
are at least partly aggregated, and
are connected via Si—O—Si bonds to a surface-modifying component and still have reactive groups on their surface;
b) at least one glycol monoether of formula (A)
H₃C(CH₂)ₘ—O—(CH₂)ₙ—[O—(CH₂)ₒ]ₚ—OH (A),
wherein
m=0, 1, 2, or 3,
n and o=2, 3, or 4, and
p=0 or 1;
c) at least one carboxylic ester of formula (B)
H₂ₓ₊₁Cₓ—O—CH₂—(CHR)—[O—CHR]_{y}—O—C(=0)-C_{z}H_{2z+1} (B),
wherein
R=H, CH₃, C₂H₅, or C₃H₇,
x and z=1, 2, or 3, and
y=0 or 1; and wherein
d) a molar ratio A/B is 10:90 to 40:60 and m, n, o, p, x, y and z are independent of one another,
to give the surface-modified silicon dioxide particles having an average particle diameter of not more than 100 nm.

11. The process according to claim 2, wherein H₃C(CH₂)₃—O—(CH₂)₂—OH is present.

12. The process according to claim 1, wherein the at least one glycol monoether b) is H₃C(CH₂)₃—O—(CH₂)₂—OH.

13. The process according to claim 2, wherein the at least one glycol monoether b) is H₃C(CH₂)₃—O—(CH₂)₂—OH.

14. The process according to claim 2, wherein is H₃C—O—CH₂—CHCH₃—O—C(═O)—CH₃ present.

15. The process according to claim 3, wherein is H₃C—O—CH₂—CHCH₃—O—C(═O)—CH₃ present.

16. The process according to claim 11, wherein is H₃C—O—CH₂—CHCH₃—O—C(═O)—CH₃ present.

17. The process according to claim 21, wherein is H₃C—O—CH₂—CHCH₃—O—C(═O)—CH₃ present.

18. The process according to claim 1, wherein the at least one carboxylic acid c) is H₃C—O—CH₂—CHCH₃—O—C(═O)—CH₃.

19. The process according to claim 2, wherein the at least one carboxylic acid c) is H₃C—O—CH₂—CHCH₃—O—C(═O)—CH₃.

20. The process according to claim 3, wherein the at least one carboxylic acid c) is H₃C—O—CH₂—CHCH₃—O—C(═O)—CH₃.
